(19) United States
(12) Patent Application Publication
(10) Pub. No.: US 2024/0405531 A1
(43) Pub. Date: Dec. 5, 2024

(54) COLLAR, FASTENED MEMBER, AND WIRE HARNESS

(71) Applicant: Yazaki Corporation, Tokyo (JP)

(72) Inventor: Toshiki IWAMA, Aichi (JP)

(73) Assignee: Yazaki Corporation, Tokyo (JP)

(21) Appl. No.: 18/678,162

(22) Filed: May 30, 2024

(30) Foreign Application Priority Data
May 31, 2023 (JP) 2023-089700

(51) Int. Cl. H02G 3/04

(52) U.S. Cl. CPC H02G 3/0437

(57) ABSTRACT

A collar includes a first member that includes a first flange portion having a plate-like shape and a first cylindrical portion, and a second member that includes a second flange portion having a plate-like shape and a second cylindrical portion, the second cylindrical portion being coupled to the first cylindrical portion. When the first cylindrical portion and the second cylindrical portion are inserted into a through hole of a mounting target member, outer diameters of the first cylindrical portion and the second cylindrical portion are smaller than a hole diameter of the through hole, and a gap is provided between outer circumferential surfaces of the first cylindrical portion and the second cylindrical portion and an inner circumferential surface of the through hole.

### CROSS-REFERENCE TO RELATED APPLICATIONS

The present application is based on, and claims priority from Japanese Patent Application No. 2023-089700, filed on May 31, 2023, the entire contents of which are incorporated herein by reference.

### TECHNICAL FIELD

The present disclosure relates to a collar, a fastened member, and a wire harness.

### BACKGROUND

Hitherto, there has been known a structure in which a metal collar is attached to a through hole of a resin mounting target member. In a case in which the metal collar is attached to the resin mounting target member, when the resin mounting target member is fastened with a metal fastening tool such as a bolt, it is possible to suppress deformation of the resin mounting target member over time due to a fastening stress and suppress occurrence of loosening of the fastening tool.

JP2016-114139A discloses that a through hole is formed in a carbon fiber reinforced resin material being a fastening object and a metal collar formed into a cylindrical shape is attached to the through hole. JP2016-114139A discloses that a flange portion at a first member of the collar abuts against a peripheral edge portion of the through hole on the front surface side of the CFRP material via an adhesive and an abutting portion at a second member of the collar abuts against a peripheral edge portion of the through hole on the back surface side of the CFRP material via an adhesive. According to the structure described in JP2016-114139A, a liquid body is prevented from entering a gap between the CFRP material and the metal collar, and hence corrosion of the metal collar is suppressed.

### SUMMARY OF THE INVENTION

In JP2016-114139A, the carbon fiber reinforced resin material and the fastened object are fastened to each other by inserting the fastening tool inside the collar and then fastening the fastening tool, and thus the fastening structure of the carbon fiber reinforced resin material is formed. However, in general, the tolerance between the cylindrical collar and the shaft portion of the bolt is narrow, allowing only a small margin for the tolerance. Further, it can be considered to form an insertion hole for a bolt into an elliptical-cylindrical shape. However, in such a case, the tolerance in only one of the vertical direction and the horizontal direction is absorbed, and hence a potential for design limitations may arise.

The present disclosure has been made in view of the problem in the related art. Further, an object of the present disclosure is to provide a collar, a fastened member, and a wire harness that allow for a wide tolerance range and are capable of dispersing a surface pressure exerted on a mounting target member.

A collar according to an aspect of the present disclosure includes a first member that includes a first flange portion having a plate-like shape and a first cylindrical portion being provided on an inner circumferential side of the first flange portion, protruding from a first protrusion surface being one surface of the first flange portion, and having a cylindrical shape. The collar includes a second member that includes a second flange portion having a plate-like shape and a second cylindrical portion being provided on an inner circumferential side of the second flange portion, protruding from a second protrusion surface being one surface of the second flange portion, and having a cylindrical shape, the second cylindrical portion being coupled to the first cylindrical portion. When the first cylindrical portion and the second cylindrical portion are inserted into a through hole of a mounting target member, outer diameters of the first cylindrical portion and the second cylindrical portion are smaller than a hole diameter of the through hole, and a gap is provided between outer circumferential surfaces of the first cylindrical portion and the second cylindrical portion and an inner circumferential surface of the through hole.

A fastened member according to another aspect of the present disclosure includes the mounting target member having the through hole and the collar including the first cylindrical portion and the second cylindrical portion that are inserted into the through hole. A gap is provided between the outer circumferential surfaces of the first cylindrical portion and the second cylindrical portion and the inner circumferential surface of the through hole.

A wire harness according to another aspect of the present disclosure includes an electric wire, and the fastened member, wherein the fastened member is a protector.

According to the present disclosure, it is possible to provide a collar, a fastened member, and a wire harness that allow for a wide tolerance range and are capable of dispersing a surface pressure exerted on a mounting target member.

### BRIEF DESCRIPTION OF THE DRAWINGS

FIG. 1 is a perspective view illustrating one example of a state before electric wires are accommodated in an electric wire accommodation space of a protector according to one embodiment.

FIG. 2 is a cross-sectional view illustrating one example of a state after the electric wires are accommodated in the electric wire accommodation space of the protector.

FIG. 3 is a schematic perspective view illustrating a state before a collar according to one embodiment is mounted to a bolt fixing portion of the protector, which is a mounting target member.

FIG. 4 is a schematic perspective view illustrating one example of the protector formed by mounting the collar according to one embodiment to the bolt fixing portion.

FIG. 5 is a cross-sectional view illustrating one example of the collar formed by assembling a first member and a second member according to one embodiment.

FIG. 6 is a perspective view illustrating one example of the first member or the second member according to one embodiment.

FIG. 7 is a cross-sectional view taken along the line VII-VII in FIG. 6.

FIG. 8 is a plan view of the first member according to one embodiment.

FIG. 9 is a cross-sectional view taken along the line IX-IX in FIG. 7.

FIG. 10 is a cross-sectional view taken along the line X-X in FIG. 7.

FIG. 11 a perspective view illustrating one example of a state in which a first cylindrical portion of the first member is inserted into a through hole of the mounting target member.

### DETAILED DESCRIPTION OF THE INVENTION

A collar, a fastened member, and a wire harness according to the present embodiment are described below in detail with reference to the drawings. Note that the dimension ratios in the drawings are exaggerated for the convenience of the description, and may be different from the actual ratios.

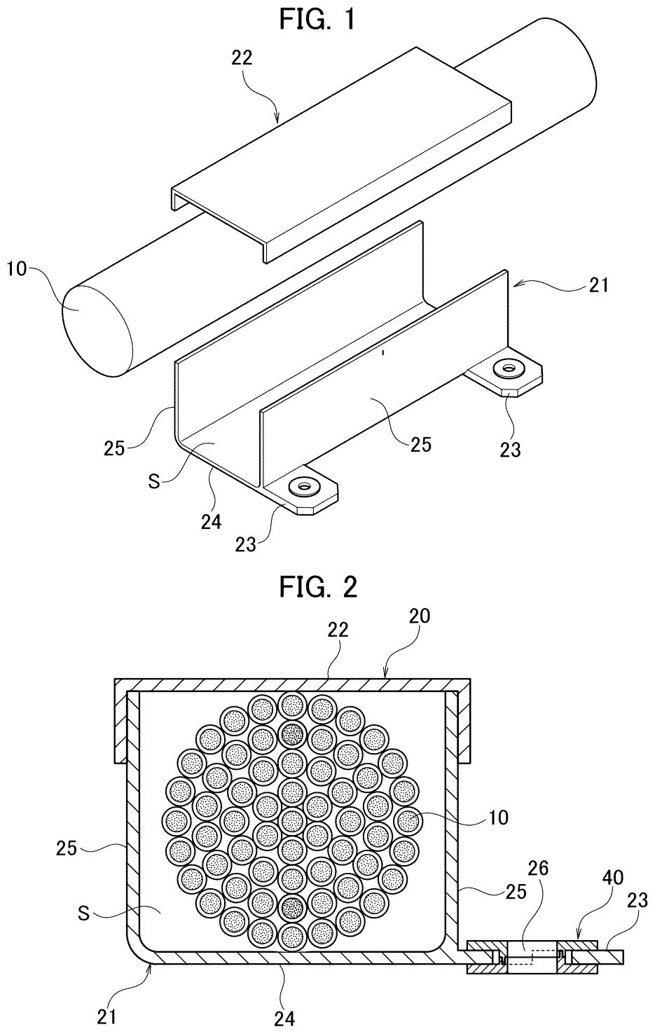

A wire harness 1 according to the present embodiment includes a plurality of electric wires 10 and a protector 20 (fastened member 20) that accommodates the plurality of electric wires 10. FIG. 1 is a perspective view illustrating one example of a state before the electric wires 10 are accommodated in an electric wire accommodation space S of the protector 20 according to one embodiment. FIG. 2 is a cross-sectional view illustrating one example of a state in which a bundle of the plurality of electric wires 10 is accommodated in the electric wire accommodation space S of the protector 20. As illustrated in FIG. 1 and FIG. 2, the wire harness 1 can be manufactured by accommodating the electric wires 10 in the protector 20.

The electric wire 10 includes a conductive body and an insulating coating layer. A terminal metal fitting, which is omitted in illustration, is mounted to one end of the electric wire 10, and the terminal metal fitting is accommodated in a housing. The protector 20 protects the electric wires 10 included in the wire harness 1 from an external force or the like. The protector 20 includes a main body portion 21, a lid portion 22, and a bolt fixing portion 23.

The main body portion 21 has a substantially U-like cross-sectional shape as viewed in a longitudinal direction of the electric wire 10, and an upper part thereof opens. The main body portion 21 includes a bottom wall portion 24 having a flat plate-like shape and a pair of side wall portions 25 extending vertically upward from both the ends of the bottom wall portion 24. The main body portion 21 includes the electric wire accommodation space S that is formed to be surrounded by the bottom wall portion 24 and the pair of side wall portions 25 and is capable of accommodating the electric wires 10. The lid portion 22 is mounted to upper ends of the pair of side wall portions 25 so as to cover the opening in the upper part of the main body portion 21 and face the bottom wall portion 24. The bolt fixing portion 23 protrudes outward from the side wall portion 25 of the main body portion 21, and includes a through hole 26 having a cylindrical shape into which a bolt, not shown, can be inserted.

A bolt is inserted into the through hole 26 of the bolt fixing portion 23 to mount the protector 20 to a vehicle body of a vehicle such as an automobile, not shown, and thereby fixation to the vehicle body can be achieved. With this, the wire harness 1 can be securely fixed to the vehicle body.

The bolt fixing portion 23 is formed by using an insulating resin. Thus, even when the protector 20 is fastened with a metal fastening tool such as a bolt by attaching a metal collar 40 to the through hole 26, it is possible to suppress deformation of the bolt fixing portion 23 formed of a resin over time due to a fastening stress and suppress occurrence of loosening of the metal fastening tool.

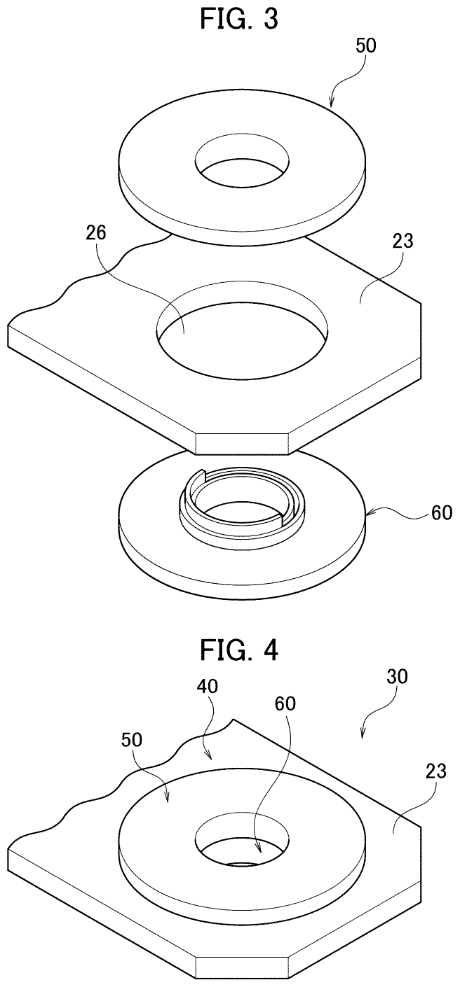

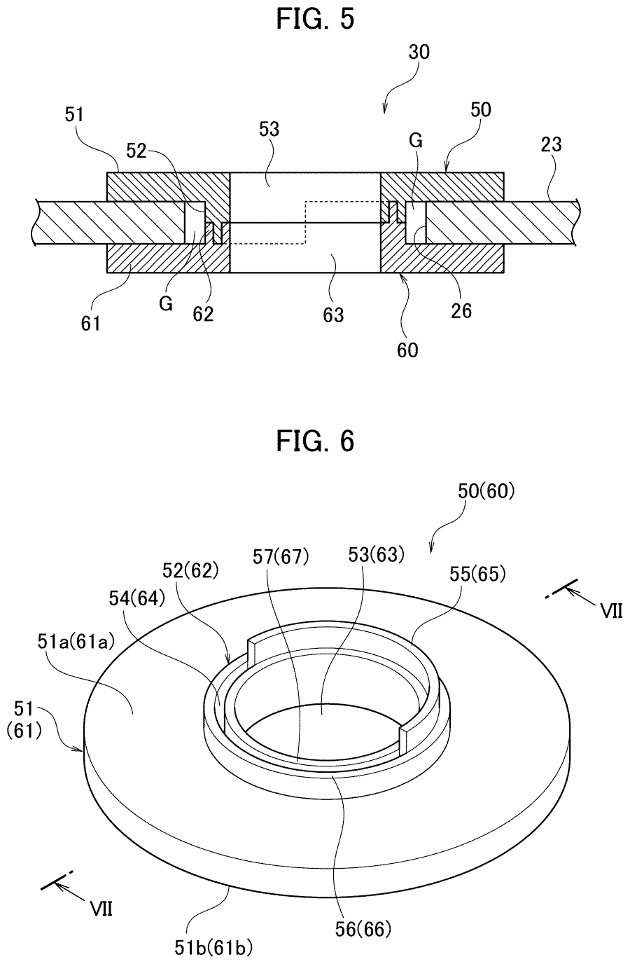

Next, the collar 40 according to the present embodiment is described in detail. FIG. 3 is a schematic perspective view illustrating a state before the collar 40 according to one embodiment is mounted to the bolt fixing portion 23 of the protector 20, which is a mounting target member 23. FIG. 4 is a schematic perspective view illustrating one example of the protector 20 formed by mounting the collar 40 according to one embodiment to the bolt fixing portion 23. FIG. 5 is a cross-sectional view illustrating one example of the collar 40 formed by assembling a first member 50 and a second member 60 according to one embodiment.

As illustrated in FIG. 2 to FIG. 4, the protector 20 (fastened member 20) includes the bolt fixing portion 23 (the mounting target member 23) including the through hole 26 and the collar 40 mounted to the through hole 26. The collar 40 includes the first member 50 and the second member 60. As illustrated in FIG. 3 to FIG. 5, the collar 40 can be formed by coupling a first cylindrical portion 52 of the first member 50 and a second cylindrical portion 62 of the second member 60 to each other. The protector 20 according to the present embodiment can be formed by inserting the first cylindrical portion 52 of the first member 50 and the second cylindrical portion 62 of the second member 60 into the through hole 26 and coupling the first cylindrical portion 52 and the second cylindrical portion 62 to each other.

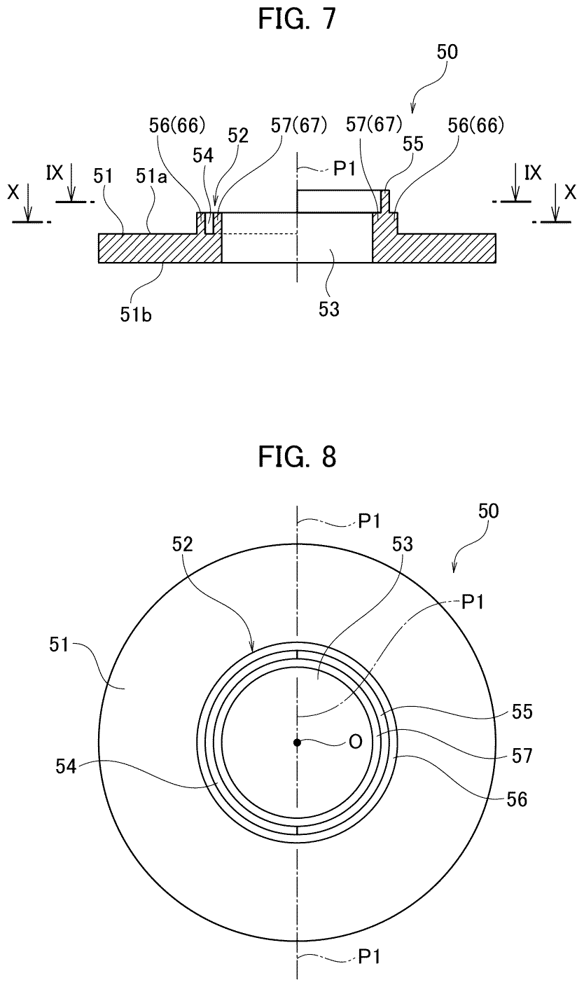

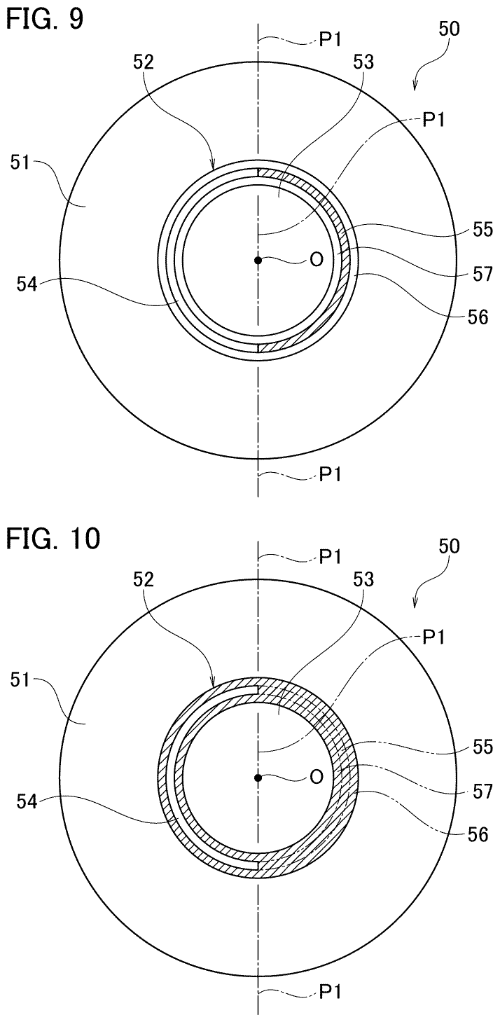

FIG. 6 is a perspective view illustrating one example of the first member 50 or the second member 60 according to one embodiment. In the present embodiment, the first member 50 and the second member 60 have an identical shape. FIG. 7 is a cross-sectional view taken along the line VII-VII in FIG. 6. FIG. 8 is a plan view of the first member 50 according to one embodiment. FIG. 9 is a cross-sectional view taken along the line IX-IX in FIG. 7. FIG. 10 is a cross-sectional view taken along the line X-X in FIG. 7. As illustrated in FIG. 6 to FIG. 10, the first member 50 includes a first flange portion 51 and the first cylindrical portion 52. Further, the first member 50 includes a first insertion hole 53 having a cylindrical shape into which the metal fastening tool such as a bolt is inserted. The second member 60 includes a second flange portion 61 and the second cylindrical portion 62. Further, the second member 60 includes a second insertion hole 63 having a cylindrical shape into which the metal fastening tool such as a bolt is inserted. The second cylindrical portion 62 is coupled to the first cylindrical portion 52.

The first flange portion 51 has a plate-like shape. Specifically, the first flange portion 51 has a disk-like shape. The first flange portion 51 includes a first protrusion surface 51a being one surface and a first non-protrusion surface 51b being a surface opposite to the first protrusion surface 51a. The first protrusion surface 51a and the first non-protrusion surface 51b are flat surfaces, and do not have a recess or a projection.

The first cylindrical portion 52 protrudes from the first protrusion surface 51a being one surface of the first flange portion 51 on an inner circumferential side of the first flange portion 51. The first cylindrical portion 52 has a cylindrical shape. The first insertion hole 53 is formed by an inner circumferential wall of the first cylindrical portion 52. The first cylindrical portion 52 includes a first recess portion 54, a first projection portion 55, a first outer circumferential wall 56, and a first inner circumferential wall 57. The first outer circumferential wall 56 has a cylindrical shape, and forms an outer circumferential wall of the first cylindrical portion 52. The first inner circumferential wall 57 has a cylindrical shape having a diameter smaller than that of the first outer circumferential wall 56, and forms the inner circumferential wall of the first cylindrical portion 52.

The first recess portion 54 is provided to a first region being one region with a first symmetric plane P1 as a reference, the first symmetric plane P1 passing through a center axis O of the first cylindrical portion 52. Specifically, the first recess portion 54 is provided to a first end surface opposite to the first flange portion 51 in an insertion direction of the first insertion hole 53 (the direction corresponding to the center axis O). The first recess portion 54 is arranged between the first outer circumferential wall 56 and the first inner circumferential wall 57 in a radial direction of the first cylindrical portion 52. The first recess portion 54 is formed to have an end surface lower than the first outer circumferential wall 56 and the first inner circumferential wall 57, and side walls of the first recess portion 54 are formed by a side wall of the first outer circumferential wall 56 and a side wall of the first inner circumferential wall 57. The first recess portion 54 has a semi-circular arc shape formed continuously along the shape of the first end surface as viewed in the direction corresponding to the center axis O of the first cylindrical portion 52.

The first projection portion 55 is provided to a second region being a region opposite to the first region with the first symmetric plane P1 as a reference. Specifically, the first projection portion 55 is provided to the first end surface. The first projection portion 55 is arranged between the first outer circumferential wall 56 and the first inner circumferential wall 57 in the radial direction of the first cylindrical portion 52. The first projection portion 55 is formed to have an end surface higher than the first outer circumferential wall 56 and the first inner circumferential wall 57. The first projection portion 55 has a semi-circular arc shape formed continuously along the shape of the first end surface as viewed in the direction corresponding to the center axis O of the first cylindrical portion 52. As understood from FIG. 7 to FIG. 10, the first recess portion 54 and the first projection portion 55 are continuous in the circumferential direction as viewed in the direction corresponding to the center axis O of the first cylindrical portion 52.

The second flange portion 61 has a plate-like shape. The second flange portion 61 includes a second protrusion surface 61a being one surface and a second non-protrusion surface 61b being a surface opposite to the second protrusion surface 61a. The second protrusion surface 61a and the second non-protrusion surface 61b are flat surfaces, and do not have a recess or a projection.

The second cylindrical portion 62 protrudes from the second protrusion surface 61a being one surface of the second flange portion 61 on an inner circumferential side of the second flange portion 61. The second cylindrical portion 62 has a cylindrical shape. The second insertion hole 63 is formed by an inner circumferential wall of the second cylindrical portion 62. The second cylindrical portion 62 includes a second recess portion 64, a second projection portion 65, a second outer circumferential wall portion 66, a second inner circumferential wall portion 67. The second outer circumferential wall portion 66 has a cylindrical shape, and forms an outer circumferential wall of the second cylindrical portion 62.

The second recess portion 64 is provided to a third region being one region with a second symmetric plane P2 as a reference, the second symmetric plane P2 passing through the center axis O of the second cylindrical portion 62. Specifically, the second recess portion 64 is provided to a second end surface opposite to the second flange portion 61 in an insertion direction of the second insertion hole 63 (the direction corresponding to the center axis O). The second recess portion 64 is arranged between the second outer circumferential wall portion 66 and the second inner circumferential wall portion 67 in a radial direction of the second cylindrical portion 62. The second recess portion 64 is formed to have an end surface lower than the second outer circumferential wall portion 66 and the second inner circumferential wall portion 67, and side walls of the second recess portion 64 are formed by a side wall of the second outer circumferential wall portion 66 and a side wall of the second inner circumferential wall portion 67. The second recess portion 64 has a semi-circular arc shape formed continuously along the shape of the second end surface as viewed in the direction corresponding to the center axis O of the second cylindrical portion 62. The second inner circumferential wall portion 67 has a cylindrical shape having a diameter smaller than that of the second outer circumferential wall portion 66, and forms the inner circumferential wall of the second cylindrical portion 62.

The second projection portion 65 is provided to a fourth region being a region opposite to the third region with the second symmetric plane P2 as a reference. Specifically, the second projection portion 65 is provided to the second end surface. The second projection portion 65 is arranged between the second outer circumferential wall portion 66 and the second inner circumferential wall portion 67 in the radial direction of the second cylindrical portion 62. The second projection portion 65 is formed to have an end surface higher than the second outer circumferential wall portion 66 and the second inner circumferential wall portion 67. The second projection portion 65 has a semi-circular arc shape formed continuously along the shape of the second end surface as viewed in the direction corresponding to the center axis O of the second cylindrical portion 62. As understood from FIG. 7 to FIG. 10, the second recess portion 64 and the second projection portion 65 are continuous in the circumferential direction as viewed in the direction corresponding to the center axis O of the second cylindrical portion 62.

As illustrated in FIG. 7, in the collar 40 according to the present embodiment, the first recess portion 54 and the second projection portion 65 are fitted to each other, and the second recess portion 64 and the first projection portion 55 are fitted to each other. Specifically, the second projection portion 65 is inserted into the first recess portion 54, and the first projection portion 55 is inserted into the second recess portion 64. With this, the first cylindrical portion 52 of the first member 50 and the second cylindrical portion 62 of the second member 60 are coupled to each other to form the collar 40. When those portions are fitted to each other, and the periphery of the through hole 26 of the bolt fixing portion 23 is sandwiched between the first protrusion surface 51a of the first flange portion 51 and the second protrusion surface 61a of the second flange portion 61, the collar 40 can be mounted to the through hole 26 of the bolt fixing portion 23, and the protector 20 can be formed.

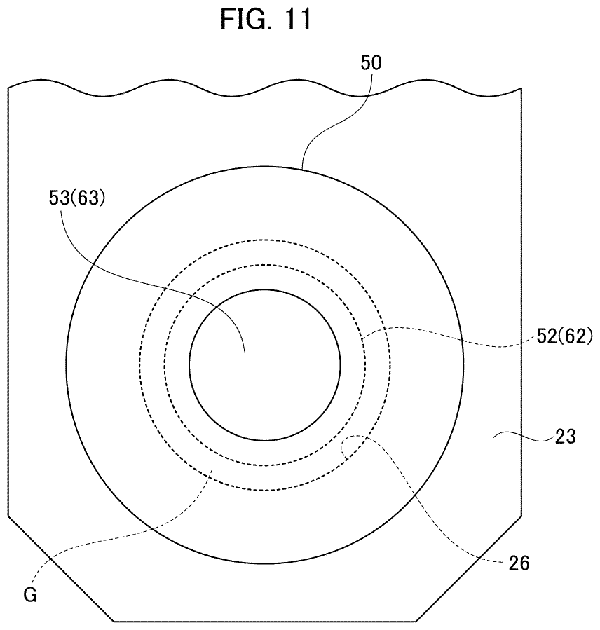

An outer diameter of the first cylindrical portion 52 and an outer diameter of the second cylindrical portion 62 are formed to be slightly smaller than a hole diameter of the through hole 26. Thus, as illustrated in FIG. 11, a gap G is provided between an outer circumferential surface of the first cylindrical portion 52 and an outer circumferential surface of the second cylindrical portion 62 and an inner circumferential surface of the through hole 26. In a case in which the gap G described above is provided, when the first cylindrical portion 52 and the second cylindrical portion 62 are inserted into the through hole 26, the first cylindrical portion 52 and the second cylindrical portion 62 are movable in a radial direction of the through hole 26, and a tolerance can be absorbed. Further, the first member 50 includes the first cylindrical portion 52 having a cylindrical shape, and the second member 60 includes the second cylindrical portion 62 having a cylindrical shape. Thus, when a tolerance occurs, it is possible to absorb the tolerance not only in one direction but also in a 360-degree full circumference direction.

In the present embodiment, the first member 50 and the second member 60 have an identical shape. In other words, the first flange portion 51, the first cylindrical portion 52, and the first insertion hole 53 have shapes identical to those of the second flange portion 61, the second cylindrical portion 62, and the second insertion hole 63, respectively. Specifically, the first protrusion surface 51a, the first non-protrusion surface 51b, the first recess portion 54, the first projection portion 55, the first outer circumferential wall 56, and the first inner circumferential wall 57 correspond to the second protrusion surface 61a, the second non-protrusion surface 61b, the second recess portion 64, the second projection portion 65, the second outer circumferential wall portion 66, and the second inner circumferential wall portion 67, respectively. In this manner, the same members are used for the first member 50 and the second member 60 to reduce the variety of the components, and thus inventory management can be simplified.

Next, effects of the collar 40, the fastened member 20, and the wire harness 1 according to the present embodiment are described.

As described above, the collar 40 according to the present embodiment includes the first member 50 including the first flange portion 51 having a plate-like shape and the first cylindrical portion 52 being provided on the inner circumferential side of the first flange portion 51, protruding from the first protrusion surface 51a being one surface of the first flange portion 51, and having a cylindrical shape. The collar 40 includes the second flange portion 61 having a plate-like shape and the second cylindrical portion 62 being provided on the inner circumferential side of the second flange portion 61, protruding from the second protrusion surface 61a being one surface of the second flange portion 61, and having a cylindrical shape, the second cylindrical portion 62 being coupled to the first cylindrical portion 52. When the first cylindrical portion 52 and the second cylindrical portion are inserted into the through hole 26 of the mounting target member 23, the outer diameters of the first cylindrical portion 52 and the second cylindrical portion 62 are smaller than the hole diameter of the through hole 26, and the gap G is provided between the outer circumferential surfaces of the first cylindrical portion 52 and the second cylindrical portion 62 and the inner circumferential surface of the through hole 26.

According to the collar 40 according to the present embodiment, the collar 40 can be formed by coupling the first cylindrical portion 52 and the second cylindrical portion 62 to each other. Thus, the collar 40 can be formed by sandwiching the periphery of the through hole 26 of the bolt fixing portion 23 between the first flange portion 51 having a plate-like shape and the second flange portion 61 having a plate-like shape. With this, a surface pressure exerted on the mounting target member 23 can be dispersed.

Further, according to the collar 40 according to the present embodiment, in a case in which the outer diameters of the first cylindrical portion 52 and the second cylindrical portion 62 are smaller than the hole diameter of the through hole 26, when the first cylindrical portion 52 and the second cylindrical portion 62 are inserted into the through hole 26, the first cylindrical portion 52 and the second cylindrical portion 62 are movable in the radial direction of the through hole 26. Thus, a tolerance can be absorbed in the radial direction of the through hole 26. Further, the first cylindrical portion 52 and the second cylindrical portion 62 have a cylindrical shape. Thus, even when the outer diameters of the first cylindrical portion 52 and the second cylindrical portion 62 are smaller than the hole diameter of the through hole 26, it is possible to absorb a tolerance not only in one direction but also in a 360-degree full circumference direction.

Thus, according to the collar 40 according to the present embodiment, a wide tolerance range is allowed, and a surface pressure exerted on the mounting target member 23 can be dispersed.

Further, the first cylindrical portion 52 may include the first recess portion 54 that is provided to the first end surface opposite to the first flange portion 51 in the first region and the first projection portion 55 that is provided to the first end surface in the second region being a region opposite to the first region with the first symmetric plane P1 as a reference. The first region may be one region with the first symmetric plane P1 as a reference, the first symmetric plane P1 passing through the center axis O of the first cylindrical portion 52. The second cylindrical portion 62 may include the second recess portion 64 that is provided to the second end surface opposite to the second flange portion 61 in the third region and the second projection portion 65 that is provided to the second end surface in the fourth region being a region opposite to the third region with the second symmetric plane P2 as a reference. The third region may be one region with the second symmetric plane P2 as a reference, the second symmetric plane P2 passing through the center axis O of the second cylindrical portion 62. The first member 50 and the second member 60 may have an identical shape. The first recess portion 54 and the second projection portion 65 may be fitted to each other, and the second recess portion 64 and the first projection portion 55 may be fitted to each other.

With this configuration, the first member 50 and the second member 60 have the same shape, and the collar 40 can be formed by using the same members. Thus, the management costs of the members can be reduced. Further, the collar 40 can be formed by fitting the first member 50 and the second member 60 to each other. Thus, the collar 40 can be formed easily without using a material such as an adhesive.

The first recess portion 54 and the first projection portion 55 may have a semi-circular arc shape formed continuously along the shape of the first end surface as viewed in the direction corresponding to the center axis O of the first cylindrical portion 52. With this shape, positioning between the first member 50 and the second member 60 can be facilitated, and the first member 50 and the second member 60 can be fitted firmly to each other.

The fastened member 20 according to the present embodiment may include the mounting target member 23 including the through hole 26 and the collar 40 including the first cylindrical portion 52 and the second cylindrical portion 62 that are inserted into the through hole 26. The gap G may be provided between the outer circumferential surfaces of the first cylindrical portion 52 and the second cylindrical portion 62 and the inner circumferential surface of the through hole 26. As described above, according to the collar 40 according to the present embodiment, a wide tolerance range is allowed, and a surface pressure exerted on the mounting target member 23 can be dispersed. Thus, as compared to a collar that absorbs a tolerance in only one of a vertical direction and a horizontal direction, the fastened member 20 that has less design restrictions and has a structure with various variations can be provided by using the collar 40 described above.

The wire harness 1 according to the present embodiment may include the electric wires 10 and the fastened member 20. The fastened member 20 may be the protector 20. As described above, when the collar 40 according to the present embodiment is used, the protector 20 having a structure with various variations can be provided. Thus, the wire harness 1 with various variations satisfying demands of consumers can be provided.

Note that, in the above-mentioned embodiment, the fastened member being the protector is described. However, the fastened member is not limited to the protector, and may be used for various applications where the collar 40 is mounted to a through hole.

Further, the mounting target member may be formed of a generic resin, engineering plastic, or a resin such as a fiber reinforced resin. Examples of the fiber reinforced resin include carbon fiber reinforced plastic (CFRP) and the like.

While the present embodiment is described above, the present embodiment is not limited thereto, and various modifications may be made within the scope of the present embodiment.

1. A collar, comprising:
a first member including:
a first flange portion having a plate-like shape; and
a first cylindrical portion being provided on an inner circumferential side of the first flange portion, protruding from a first protrusion surface being one surface of the first flange portion, and having a cylindrical shape; and
a second member including:
a second flange portion having a plate-like shape; and
a second cylindrical portion being provided on an inner circumferential side of the second flange portion, protruding from a second protrusion surface being one surface of the second flange portion, and having a cylindrical shape, the second cylindrical portion being coupled to the first cylindrical portion, wherein
when the first cylindrical portion and the second cylindrical portion are inserted into a through hole of a mounting target member, outer diameters of the first cylindrical portion and the second cylindrical portion are smaller than a hole diameter of the through hole, and a gap is provided between outer circumferential surfaces of the first cylindrical portion and the second cylindrical portion and an inner circumferential surface of the through hole.

2. The collar according to claim 1, wherein
the first cylindrical portion includes:
a first recess portion being provided to a first end surface opposite to the first flange portion in a first region being one region with a first symmetric plane as a reference, the first symmetric plane passing through a center axis of the first cylindrical portion; and
a first projection portion being provided to the first end surface in a second region being a region opposite to the first region with the first symmetric plane as a reference,
the second cylindrical portion includes:
a second recess portion being provided to a second end surface opposite to the second flange portion in a third region being one region with a second symmetric plane as a reference, the second symmetric plane passing through a center axis of the second cylindrical portion; and
a second projection portion being provided to the second end surface in a fourth region being a region opposite to the third region with the second symmetric plane as a reference,
the first member and the second member have an identical shape, and
the first recess portion and the second projection portion are fitted to each other, and the second recess portion and the first projection portion are fitted to each other.

3. The collar according to claim 2, wherein
the first recess portion and the first projection portion have a semi-circular arc shape formed continuously along a shape of the first end surface as viewed in a center axis direction of the first cylindrical portion.

4. A fastened member, comprising:
the mounting target member having the through hole; and
the collar according to claim 1, including the first cylindrical portion and the second cylindrical portion that are inserted into the through hole, wherein
the gap is provided between the outer circumferential surfaces of the first cylindrical portion and the second cylindrical portion and the inner circumferential surface of the through hole.

5. A wire harness, comprising:
an electric wire; and
the fastened member according to claim 4, wherein
the fastened member is a protector.
